(19) United States
(12) Patent Application Publication
(10) Pub. No.: US 2026/0120656 A1
(43) Pub. Date: Apr. 30, 2026

(54) METHODS FOR DRIVING ELECTRO-OPTIC DISPLAYS

(71) Applicant: E INK CORPORATION, Billerica, MA (US)

(72) Inventors: Teck Ping SIM, Acton, MA (US); Jaya KUMAR, Kuala Lumpur (MY); Yuval BEN-DOV, Cambridge, MA (US)

(21) Appl. No.: 19/375,561

(22) Filed: Oct. 31, 2025

Related U.S. Application Data
(60) Provisional application No. 63/714,857, filed on Oct. 31, 2024.

(51) Int. Cl. G09G 3/34; G09G 3/20

(52) U.S. Cl. CPC G09G 3/344; G09G 3/2092; G09G 2340/14

(57) ABSTRACT

Methods are provided for driving electro-optic displays, particularly electrophoretic displays, to enable rapid image transfer for animation and video applications. These methods address the technical problem of transfer bottlenecks by remapping 8-bit pixel data (Y8) to reduced-bit formats (Y1 or Y2) prior to transfer, thereby significantly reducing data size and transfer time. The method also describes multiple formats for organizing the pixel data into data packets. Such remapped data may be expanded back to Y8 format within the display controller for subsequent processing and presentation. Because the data is reduced before transmission, the system enables efficient animation and video playback on high-resolution electrophoretic displays, ensuring smooth sequential content updates without overwhelming the available data links.

### CROSS-REFERENCE TO RELATED APPLICATIONS

This application claims priority to U.S. Provisional Application No. 63/714,857, filed on Oct. 31, 2024.

The entire disclosure of the aforementioned application and any patent, published application, or other published work referred to below are incorporated by reference herein in their entireties.

### FIELD OF THE INVENTION

The subject matter disclosed herein relates to methods for driving electro-optic displays, especially bistable electro-optic displays, and to apparatuses for carrying out such methods. More specifically, the subject matter disclosed herein relates to driving methods enabling rapid transfer of images to electrophoretic displays for animation and video applications.

### BACKGROUND OF THE INVENTION

An electrophoretic display (EPD) changes color by modifying the position of a charged colored particle with respect to a light-transmissive viewing surface. Such electrophoretic displays are typically referred to as “electronic paper” or “ePaper” because the resulting display has high contrast and is sunlight-readable, much like ink on paper. Electrophoretic displays have enjoyed widespread adoption in eRreaders, such as the AMAZON KINDLE® because the electrophoretic displays provide a book-like reading experience, use little power, and allow a user to carry a library of hundreds of books in a lightweight handheld device.

For many years, electrophoretic displays included only two types of charged color particles, black and white. (To be sure, “color” as used herein includes black and white, and intermediate gray levels or grayscale levels between them.) The white particles are often of the light scattering type, and comprise, e.g., titanium dioxide, while the black particles are absorptive across the visible spectrum, and may comprise carbon black, or an absorptive metal oxide, such as copper chromite. In the simplest sense, a black and white electrophoretic display only requires a light-transmissive electrode at the viewing surface, a back electrode, and an electrophoretic medium including oppositely charged white and black particles. When a voltage of one polarity is provided, the white particles move to the viewing surface, and when a voltage of the opposite polarity is provided the black particles move to the viewing surface. If the back electrode includes controllable regions (pixels)—either segmented electrodes or an active matrix of pixel electrodes controlled by transistors—a pattern can be made to appear electronically at the viewing surface. The pattern can be, for example, the text to a book.

More recently, a variety of color options have become commercially available for electrophoretic displays, including three-color displays (black, white, red; black, white, yellow), and four color displays (black, white, red, yellow). Similar to the operation of black and white electrophoretic displays, electrophoretic displays with three or four reflective pigments operate similar to the simple black and white displays because the desired color particle is driven to the viewing surface. The driving schemes are far more complicated than only black and white, but in the end, the optical function of the particles is the same.

Advanced Color electronic Paper (ACeP®) also includes four particles, but the cyan, yellow, and magenta particles are subtractive rather than reflective, thereby allowing thousands of colors to be produced at each pixel. The color process is functionally equivalent to the printing methods that have long been used in offset printing and ink-jet printers. A given color is produced by using the correct ratio of cyan, yellow, and magenta on a bright white paper background. In the instance of ACeP, the relative positions of the cyan, yellow, magenta and white particles with respect to the viewing surface will determine the color at each pixel. While this type of electrophoretic display allows for thousands of colors at each pixel, it is critical to carefully control the position of each of the (50 to 500 nanometer-sized) pigments within a working space of about 10 to 20 micrometers in thickness. Obviously, variations in the position of the pigments will result in incorrect colors being displayed at a given pixel. Accordingly, exquisite voltage control is required for such a system. More details of this system are available in the following U.S. Patents, all of which are incorporated by reference in their entireties: U.S. Pat. Nos. 9,361,836, 9,921,451, 10,276,109, 10,353,266, 10,467,984, and 10,593,272.

The term gray state is used herein in its conventional meaning in the imaging art to refer to a state intermediate two extreme optical states of a pixel, and does not necessarily imply a black-white transition between these two extreme states. For example, several of the E Ink patents and published applications referred to below describe electrophoretic displays in which the extreme states are white and deep blue, so that an intermediate gray state would actually be pale blue. Indeed, as already mentioned, the change in optical state may not be a color change at all. The terms black and white may be used hereinafter to refer to the two extreme optical states of a display, and should be understood as normally including extreme optical states which are not strictly black and white, for example the aforementioned white and dark blue states.

The terms bistable and bistability are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, for example at least four times, the minimum duration of the addressing pulse required to change the state of the display element. It is shown in U.S. Pat. No. 7,170,670 that some particle-based electrophoretic displays capable of gray scale are stable not only in their extreme black and white states but also in their intermediate gray states, and the same is true of some other types of electro-optic displays. This type of display is properly called multi-stable rather than bistable, although for convenience the term bistable may be used herein to cover both bistable and multi-stable displays.

The term impulse, when used to refer to driving an electrophoretic display, is used herein to refer to the integral of the applied voltage with respect to time during the period in which the display is driven.

A particle that absorbs, scatters, or reflects light, either in a broad band or at selected wavelengths, is referred to herein as a colored or pigment particle. Various materials other than pigments (in the strict sense of that term as meaning insoluble colored materials) that absorb or reflect light, such as dyes or photonic crystals, etc., may also be used in the electrophoretic media and displays of the present invention.

Particle-based electrophoretic displays have been the subject of intense research and development for a number of years. In such displays, a plurality of charged particles (sometimes referred to as pigment particles) move through a fluid under the influence of an electric field. Electrophoretic displays can have attributes of good brightness and contrast, wide viewing angles, state bistability, and low power consumption when compared with liquid crystal displays. Nevertheless, problems with the long-term image quality of these displays have prevented their widespread usage. For example, particles that make up electrophoretic displays tend to settle, resulting in inadequate service-life for these displays.

As noted above, electrophoretic media require the presence of a fluid. In most prior art electrophoretic media, this fluid is a liquid, but electrophoretic media can be produced using gaseous fluids; see, for example, Kitamura, T., et al., Electrical toner movement for electronic paper-like display, IDW Japan, 2001, Paper HCS1-1, and Yamaguchi, Y., et al., Toner display using insulative particles charged triboelectrically, IDW Japan, 2001, Paper AMD4-4). See also U.S. Pat. Nos. 7,321,459 and 7,236,291. Such gas-based electrophoretic media appear to be susceptible to the same types of problems due to particle settling as liquid-based electrophoretic media, when the media are used in an orientation which permits such settling, for example in a sign where the medium is disposed in a vertical plane. Indeed, particle settling appears to be a more serious problem in gas-based electrophoretic media than in liquid-based ones, since the lower viscosity of gaseous suspending fluids as compared with liquid ones allows more rapid settling of the electrophoretic particles.

Numerous patents and applications assigned to or in the names of the Massachusetts Institute of Technology (MIT) and E Ink Corporation describe various technologies used in encapsulated electrophoretic and other electro-optic media. Such encapsulated media comprise numerous small capsules, each of which itself comprises an internal phase containing electrophoretically-mobile particles in a fluid medium, and a capsule wall surrounding the internal phase. Typically, the capsules are themselves held within a polymeric binder to form a coherent layer positioned between two electrodes. The technologies described in these patents and applications include:
(a) Electrophoretic particles, fluids and fluid additives; see for example U.S. Pat. Nos. 7,002,728 and 7,679,814;
(b) Capsules, binders and encapsulation processes; see for example U.S. Pat. Nos. 6,922,276 and 7,411,719;
(c) Microcell structures, wall materials, and methods of forming microcells; see for example U.S. Pat. Nos. 7,072,095 and 9,279,906;
(d) Methods for filling and sealing microcells; see for example U.S. Pat. Nos. 7,144,942 and 7,715,088;
(e) Films and sub-assemblies containing electro-optic materials; see for example U.S. Pat. Nos. 6,982,178 and 7,839,564;
(f) Backplanes, adhesive layers and other auxiliary layers and methods used in displays; see for example U.S. Pat. Nos. 7,116,318 and 7,535,624;
(g) Color formation color adjustment; see for example U.S. Pat. Nos. 6,017,584; 6,545,797; 6,664,944; 6,788,452; 6,864,875; 6,914,714; 6,972,893; 7,038,656; 7,038,670; 7,046,228; 7,052,571; 7,075,502; 7,167,155; 7,385,751; 7,492,505; 7,667,684; 7,684,108; 7,791,789; 7,800,813; 7,821,702; 7,839,564; 7,910,175; 7,952,790; 7,956,841; 7,982,941; 8,040,594; 8,054,526; 8,098,418; 8,159,636; 8,213,076; 8,363,299; 8,422,116; 8,441,714; 8,441,716; 8,466,852; 8,503,063; 8,576,470; 8,576,475; 8,593,721; 8,605,354; 8,649,084; 8,670,174; 8,704,756; 8,717,664; 8,786,935; 8,797,634; 8,810,899; 8,830,559; 8,873,129; 8,902,153; 8,902,491; 8,917,439; 8,964,282; 9,013,783; 9,116,412; 9,146,439; 9,164,207; 9,170,467; 9,170,468; 9,182,646; 9,195,111; 9,199,441; 9,268,191; 9,285,649; 9,293,511; 9,341,916; 9,360,733; 9,361,836; 9,383,623; and 9,423,666; and U.S. Patent Applications Publication Nos. 2008/0043318; 2008/0048970; 2009/0225398; 2010/0156780; 2011/0043543; 2012/0326957; 2013/0242378; 2013/0278995; 2014/0055840; 2014/0078576; 2014/0340430; 2014/0340736; 2014/0362213; 2015/0103394; 2015/0118390; 2015/0124345; 2015/0198858; 2015/0234250; 2015/0268531; 2015/0301246; 2016/0011484; 2016/0026062; 2016/0048054; 2016/0116816; 2016/0116818; and 2016/0140909;
(h) Methods for driving displays; see for example U.S. Pat. Nos. 5,930,026; 6,445,489; 6,504,524; 6,512,354; 6,531,997; 6,753,999; 6,825,970; 6,900,851; 6,995,550; 7,012,600; 7,023,420; 7,034,783; 7,061,166; 7,061,662; 7,116,466; 7,119,772; 7,177,066; 7,193,625; 7,202,847; 7,242,514; 7,259,744; 7,304,787; 7,312,794; 7,327,511; 7,408,699; 7,453,445; 7,492,339; 7,528,822; 7,545,358; 7,583,251; 7,602,374; 7,612,760; 7,679,599; 7,679,813; 7,683,606; 7,688,297; 7,729,039; 7,733,311; 7,733,335; 7,787,169; 7,859,742; 7,952,557; 7,956,841; 7,982,479; 7,999,787; 8,077,141; 8,125,501; 8,139,050; 8,174,490; 8,243,013; 8,274,472; 8,289,250; 8,300,006; 8,305,341; 8,314,784; 8,373,649; 8,384,658; 8,456,414; 8,462, 102; 8,514,168; 8,537,105; 8,558,783; 8,558,785; 8,558,786; 8,558,855; 8,576,164; 8,576,259; 8,593,396; 8,605,032; 8,643,595; 8,665,206; 8,681,191; 8,730,153; 8,810,525; 8,928,562; 8,928,641; 8,976,444; 9,013,394; 9,019,197; 9,019,198; 9,019,318; 9,082,352; 9,171,508; 9,218,773; 9,224,338; 9,224,342; 9,224,344; 9,230,492; 9,251,736; 9,262,973; 9,269,311; 9,299,294; 9,373,289; 9,390,066; 9,390,661; and 9,412,314; and U.S. Patent Applications Publication Nos. 2003/0102858; 2004/0246562; 2005/0253777; 2007/0091418; 2007/0103427; 2007/0176912; 2008/0024429; 2008/0024482; 2008/0136774; 2008/0291129; 2008/0303780; 2009/0174651; 2009/0195568; 2009/0322721; 2010/0194733; 2010/0194789; 2010/0220121; 2010/0265561; 2010/0283804; 2011/0063314; 2011/0175875; 2011/0193840; 2011/0193841; 2011/0199671; 2011/0221740; 2012/0001957; 2012/0098740; 2013/0063333; 2013/0194250; 2013/0249782; 2013/0321278; 2014/0009817; 2014/0085355; 2014/0204012; 2014/0218277; 2014/0240210; 2014/0240373; 2014/0253425; 2014/0292830; 2014/0293398; 2014/0333685; 2014/0340734; 2015/0070744; 2015/0097877; 2015/0109283; 2015/0213749; 2015/0213765; 2015/0221257; 2015/0262255; 2015/0262551; 2016/0071465; 2016/0078820; 2016/0093253; 2016/0140910; and 2016/0180777 (these patents and applications may hereinafter be referred to as the MEDEOD (MEthods for Driving Electro-optic Displays) applications);
(i) Applications of displays; see for example U.S. Pat. Nos. 7,312,784 and 8,009,348; and
(j) Non-electrophoretic displays, as described in U.S. Pat. No. 6,241,921; and U.S. Patent Applications Publication Nos. 2015/0277160; and U.S. Patent Application Publications Nos. 2015/0005720 and 2016/0012710.

Many of the aforementioned patents and applications recognize that the walls surrounding the discrete microcapsules in an encapsulated electrophoretic medium could be replaced by a continuous phase, thus producing a so-called polymer-dispersed electrophoretic display, in which the electrophoretic medium comprises a plurality of discrete droplets of an electrophoretic fluid and a continuous phase of a polymeric material, and that the discrete droplets of electrophoretic fluid within such a polymer-dispersed electrophoretic display may be regarded as capsules or microcapsules even though no discrete capsule membrane is associated with each individual droplet; see for example, U.S. Pat. No. 6,866,760. Accordingly, for purposes of the present application, such polymer-dispersed electrophoretic media are regarded as sub-species of encapsulated electrophoretic media.

A related type of electrophoretic display is a so-called microcell electrophoretic display. In a microcell electrophoretic display, the charged particles and the fluid are not encapsulated within microcapsules but instead are retained within a plurality of cavities formed within a carrier medium, typically a polymeric film. See, for example, U.S. Pat. Nos. 6,672,921 and 6,788,449.

Although electrophoretic media are often opaque (since, for example, in many electrophoretic media, the particles substantially block transmission of visible light through the display) and operate in a reflective mode, many electrophoretic displays can be made to operate in a so-called shutter mode in which one display state is substantially opaque and one is light-transmissive. See, for example, U.S. Pat. Nos. 5,872,552; 6,130,774; 6,144,361; 6,172,798; 6,271,823; 6,225,971; and 6, 184,856. Dielectrophoretic displays, which are similar to electrophoretic displays but rely upon variations in electric field strength, can operate in a similar mode; see U.S. Pat. No. 4,418,346. Other types of electro-optic displays may also be capable of operating in shutter mode. Electro-optic media operating in shutter mode can be used in multi-layer structures for full color displays; in such structures, at least one layer adjacent the viewing surface of the display operates in shutter mode to expose or conceal a second layer more distant from the viewing surface.

An encapsulated electrophoretic display typically does not suffer from the clustering and settling failure mode of traditional electrophoretic devices and provides further advantages, such as the ability to print or coat the display on a wide variety of flexible and rigid substrates. (Use of the word printing is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; electrophoretic deposition (See U.S. Pat. No. 7,339,715); and other similar techniques.) Thus, the resulting display can be flexible. Further, because the display medium can be printed (using a variety of methods), the display itself can be made inexpensively.

As indicated above most simple prior art electrophoretic media essentially display only two colors, with a gradient between the black and white extremes, known as “grayscale.” Such electrophoretic media either use a single type of electrophoretic particle having a first color in a colored fluid having a second, different color (in which case, the first color is displayed when the particles lie adjacent the viewing surface of the display and the second color is displayed when the particles are spaced from the viewing surface), or first and second types of electrophoretic particles having differing first and second colors in an uncolored fluid (in which case, the first color is displayed when the first type of particles lie adjacent the viewing surface of the display and the second color is displayed when the second type of particles lie adjacent the viewing surface). Typically the two colors are black and white. If a full color display is desired, a color filter array may be deposited over the viewing surface of the monochrome (black and white) display.

Displays with color filter arrays rely on area sharing and color blending to create color stimuli. The available display area is shared between three or four primary colors such as red/green/blue (RGB) or red/green/blue/white (RGBW), and the filters can be arranged in one-dimensional (stripe) or two-dimensional (2×2) repeat patterns. Other choices of primary colors or more than three primaries are also known in the art. The three (in the case of RGB displays) or four (in the case of RGBW displays) sub-pixels are chosen small enough so that at the intended viewing distance they visually blend together to a single pixel with a uniform color stimulus (‘color blending’). The inherent disadvantage of area sharing is that the colorants are always present, and colors can only be modulated by switching the corresponding pixels of the underlying monochrome display to white or black (switching the corresponding primary colors on or off). For example, in an ideal RGBW display, each of the red, green, blue and white primaries occupy one fourth of the display area (one sub-pixel out of four), with the white sub-pixel being as bright as the underlying monochrome display white, and each of the colored sub-pixels being no lighter than one third of the monochrome display white. The brightness of the white color shown by the display as a whole cannot be more than one half of the brightness of the white sub-pixel (white areas of the display are produced by displaying the one white sub-pixel out of each four, plus each colored sub-pixel in its colored form being equivalent to one third of a white sub-pixel, so the three colored sub-pixels combined contribute no more than the one white sub-pixel). The brightness and saturation of colors is lowered by area-sharing with color pixels switched to black. Area sharing is especially problematic when mixing yellow because it is lighter than any other color of equal brightness, and saturated yellow is almost as bright as white. Switching the blue pixels (one fourth of the display area) to black makes the yellow too dark.

U.S. Pat. Nos. 8,576,476 and 8,797,634 describe multicolor electrophoretic displays having a single back plane comprising independently addressable pixel electrodes and a common, light-transmissive front electrode. The common, light-transmissive front electrode is also known as the top electrode. Between the back plane and the front electrode is disposed a plurality of electrophoretic layers. Displays described in these applications are capable of rendering any of the primary colors (red, green, blue, cyan, magenta, yellow, white and black) at any pixel location. However, there are disadvantages to the use of multiple electrophoretic layers located between a single set of addressing electrodes. The electric field experienced by the particles in a particular layer is lower than would be the case for a single electrophoretic layer addressed with the same voltage. In addition, optical losses in an electrophoretic layer closest to the viewing surface (for example, caused by light scattering or unwanted absorption) may affect the appearance of images formed in underlying electrophoretic layers.

Attempts have been made to provide full-color electrophoretic displays using a single electrophoretic layer. For example, U.S. Pat. No. 8,917,439 describes a color display comprising an electrophoretic fluid that comprises one or two types of pigment particles dispersed in a clear and colorless or colored solvent, the electrophoretic fluid being disposed between a common electrode and a plurality of pixel or driving electrodes. The driving electrodes are arranged to expose a background layer. U.S. Pat. No. 9,116,412 describes a method for driving a display cell filled with an electrophoretic fluid comprising two types of charged particles carrying opposite charge polarities and of two contrast colors. The two types of pigment particles are dispersed in a colored solvent or in a solvent with non-charged or slightly charged colored particles dispersed therein. The method comprises driving the display cell to display the color of the solvent or the color of the non-charged or slightly charged colored particles by applying a driving voltage that is about 1 to about 20% of the full driving voltage. U.S. Pat. Nos. 8,717,664 and 8,964,282 describe an electrophoretic fluid, and a method for driving an electrophoretic display. The fluid comprises first, second and third type of pigment particles, all of which are dispersed in a solvent or solvent mixture. The first and second types of pigment particles carry opposite charge polarities, and the third type of pigment particles has a charge level being less than about 50% of the charge level of the first or second type. The three types of pigment particles have different levels of threshold voltage, or different levels of mobility, or both. None of these patent applications disclose full color display in the sense in which that term is used below, that is capable of achieving at least eight independent colors (white, red, green, blue, cyan, yellow, magenta, and black). As has been described previously, the gamut (color space) that results from electrophoretic display systems, such as Advanced Color electronic Paper can be variable depending upon environmental conditions and the chosen driving waveforms. See for example, U.S. Pat. No. 10,467,984, which is incorporated by reference in its entirety.

Algorithms for more efficiently rendering animated and video content have been described that take advantage of the fact that when playing video, the sequence of images is often known far in advance and can be preprocessed. However, with the advent of streamed media, animated and video content are often accessed by a display on an “on demand” basis without ample time for significant preprocessing.

### SUMMARY OF THE INVENTION

There is a need for methods for reducing the transfer time of sequenced image data such as animation and video content from a host system to the display controller of an electrophoretic display.

Accordingly, in one aspect, the subject matter described herein includes a method for driving an electro-optic display having a plurality of display pixels. The method includes receiving a first data packet comprising pixel data in a first pixel data format. The pixel data corresponding to a first plurality of consecutive images from a sequence of images. The method also includes remapping the pixel data in the first pixel data format to a second pixel data format. The method also includes assembling a first image of the first plurality of consecutive images from the pixel data in the second pixel data format, and updating the electro-optic display with the first image.

In some embodiments, the pixel data comprises color information about the plurality of display pixels. In some embodiments, the first pixel data format encodes the color information about the plurality of display pixels into one bit per display pixel. In some embodiments, the first pixel data format encodes the color information about the plurality of display pixels into two bits per display pixel. In some embodiments, the second pixel data format encodes the color information about the plurality of display pixels into eight bits per display pixel.

In some embodiments, the first data packet is arranged such that in each byte of the first data packet, each bit corresponds to a same pixel location from eight different images. In some embodiments, the first data packet is arranged such that in each byte of the first data packet, each bit corresponds to a different pixel location from a same image.

In some embodiments, the method further includes assembling each additional image of the first plurality of consecutive images from the pixel data in the second pixel data format, and sequentially updating the electro-optic display with the additional images of the first plurality of consecutive images.

In some embodiments, the method further includes receiving a second data packet comprising pixel data in the first pixel data format, the pixel data corresponding to a second plurality of consecutive images from the sequence of images, and remapping the pixel data in the first pixel data format to the second pixel data format before all images from the first data packet have been updated to the electro-optic display.

In some embodiments, updating the electro-optic display includes applying a fast update waveform selected from a Direct Update (DU) driving mode or an Animation (A2) driving mode.

In another aspect, the subject matter disclosed herein includes a method for transferring and displaying a sequence of images on an electrophoretic display comprising a plurality of display pixels. The method includes remapping, by a host system, a plurality of consecutive images from the sequence of images an eight-bit-per-pixel format (Y8) to a reduced-bit format selected from a one-bit-per-pixel format (Y1) or a two-bit-per-pixel format (Y2). The method also includes packetizing, by the host system, the remapped images into a series of bytes such that each bit within a byte corresponds to pixel data for the images in the sequence of images. The method also includes transmitting, by the host system, the packetized remapped images to an update buffer of a display controller of the electrophoretic display. The method also includes processing, by the display controller, each byte of the packetized remapped images to extract pixel data for each image in the sequence. The method also includes expanding, by the display controller, each bit of the extracted pixel data from the one-bit-per-pixel format (Y1) or the two-bit-per-pixel format (Y2) to an eight-bit-per-pixel format (Y8) to reassemble each image of the sequence of images. The method also includes sequentially updating, by the display controller, the electrophoretic display with each reassembled image of the sequence of images.

In some embodiments, the pixel data includes color information about the plurality of display pixels. In some embodiments, the series of bytes is arranged such that in each byte, each bit corresponds to a same pixel location from eight different images. In some embodiments, the series of bytes is arranged such that in each byte, each bit corresponds to a different pixel location from a same image.

In some embodiments, sequentially updating the electrophoretic display includes applying a fast update waveform selected from a Direct Update (DU) driving mode or an Animation (A2) driving mode.

These and other features will be more clearly understood from the following detailed description taken in conjunction with the accompanying drawings and claims.

### BRIEF DESCRIPTION OF DRAWINGS

FIG. 1A is a schematic cross-section showing an embodiment of an encapsulated electrophoretic display suitable for use with the methods of the invention.

FIG. 1B is a schematic cross-section showing an embodiment of an encapsulated electrophoretic display suitable for use with the methods of the invention.

FIG. 2 is a diagrammatic view of an exemplary driving system for controlling voltages provided to pixel electrodes in an active matrix device. The resulting driving voltages (e.g., waveforms) can be used to set an optical state of a multi-particle electrophoretic medium.

FIG. 3 illustrates an exemplary electrophoretic display that includes a display module. The electrophoretic display also includes a processor, non-transitory memory, one or more power supplies, and a controller. The electrophoretic display may also include sensors to allow the electrophoretic display to adjust operational parameters based upon the ambient environment, e.g., temperature and illumination.

FIG. 4 illustrates an idealized timeline for updating a display with a sequence of images.

FIG. 5 is a diagram illustrating pixel data organized into two sequences using different pixel data formats (Y8 and Y1).

FIG. 6. is a diagram illustrating pixel data organized into two sequences using different pixel data formats (Y8 and Y2).

FIG. 7 a diagram illustrating an exemplary byte format for packet of remapped image data for x consecutive images.

FIG. 8 is a timing diagram showing the transfer of packets of remapped pixel data to be processed and displayed on an electrophoretic display.

### DETAILED DESCRIPTION OF THE INVENTION

The inventive method described herein resolves a bottleneck in the transfer of image data for animation and video content from the host system to the display by remapping Y8 image data to Y1 or Y2 image data prior to transfer.

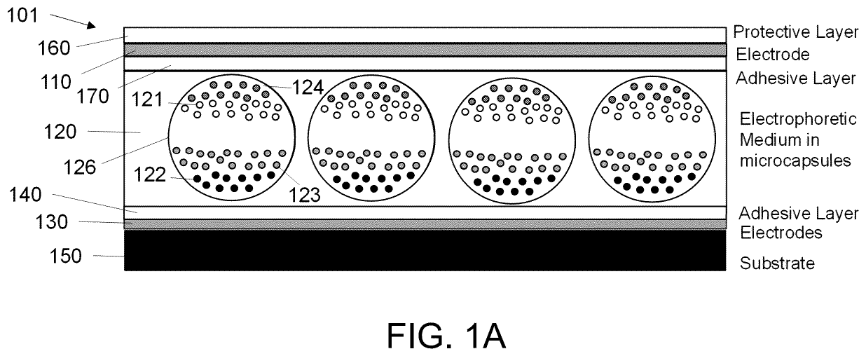

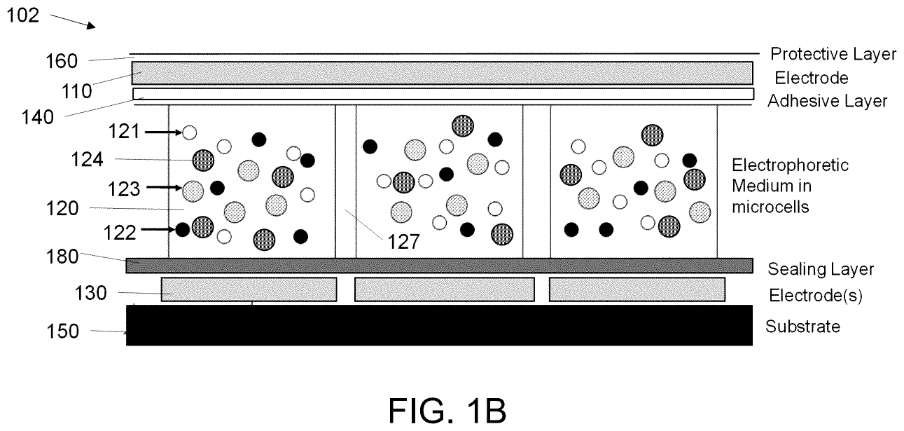

Regarding FIGS. 1A and 1B, an electrophoretic display (101, 102) typically includes a top light-transmissive electrode 110, an electrophoretic medium 120, and bottom drive electrodes 130/135, which are often pixel electrodes of an active matrix of pixels controlled with thin film transistors (TFT). Alternatively, bottom drive electrodes 130/135 may be directly wired to a controller or some other switch that provides voltage to the bottom drive electrodes 130/135 to effect a change in the optical state of the electrophoretic medium 120, i.e., segmented electrodes. Importantly, it is not necessary that a junction between drive electrodes 130/135 corresponds with an intersection of microcapsules or with a wall 127 of a microcell. Because the electrophoretic medium 120 is sufficiently thin, and the capsules or microcells sufficiently wide, the pattern of the drive electrodes (square, circles, hexagons, wavy, text, or otherwise) will show when the display is viewed from the viewing surface; not the pattern of the containers. The electrophoretic medium 120 contains at least one electrophoretic particle 121, however a second electrophoretic particle 122, or a third electrophoretic particle 123, a fourth electrophoretic particle 124, or more particles is feasible. (It should be noted that third electrophoretic particles 123 and fourth electrophoretic particles 124 can be included within the microcapsules 126 of FIG. 1, but have been omitted for clarity.) The electrophoretic medium 120 typically includes a solvent, such as isoparaffins, and may also include dispersed polymers and charge control agents to facilitate state stability, e.g. bistability, i.e., the ability to maintain an electro-optic state without inputting any additional energy.

The electrophoretic medium 120 is typically compartmentalized such by a microcapsule 126 or the walls of a microcell 127. The entire display stack is typically disposed on a substrate 150, which may be rigid or flexible. The display (101, 102) typically also includes a protective layer 160, which may simply protect the top electrode 110 from damage, or it may envelop the entire display (101, 102) to prevent ingress of water, etc. Electrophoretic displays (101, 102) may also include one or more adhesive layers 140, 170, and/or sealing layers 180 as needed. In some embodiments an adhesive layer may include a primer component to improve adhesion to the electrode layer 110, or a separate primer layer (not shown in FIG. 1A or 1B) may be used. (The structures of electrophoretic displays and the component parts, pigments, adhesives, electrode materials, etc., are described in many patents and patent applications published by E Ink Corporation, such as U.S. Pat. Nos. 6,922,276; 7,002,728; 7,072,095; 7,116,318; 7,715,088; and 7,839,564, all of which are incorporated by reference herein in their entireties.

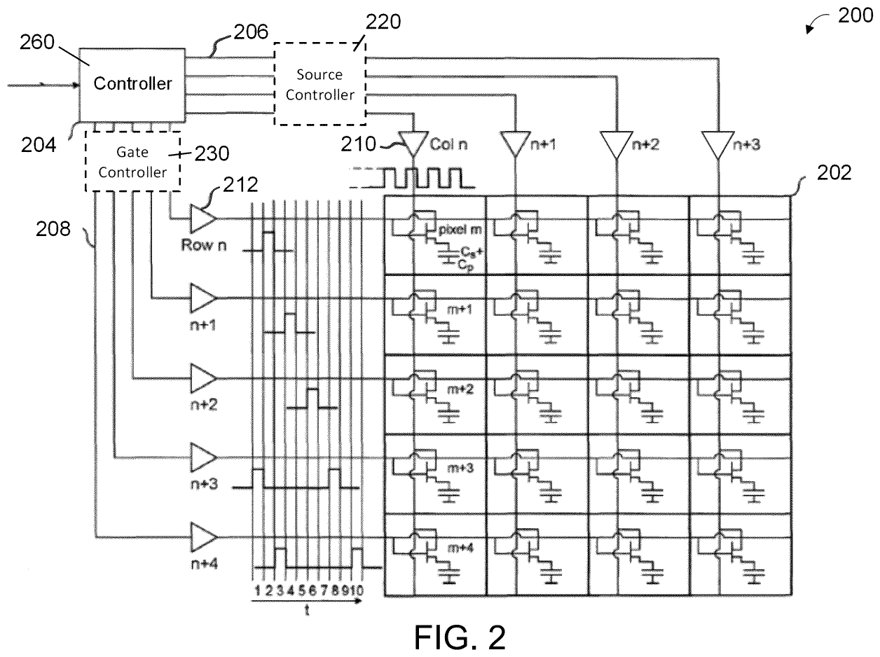

In some embodiments, e.g., as shown in FIG. 1B, the electrophoretic display may include a light-transmissive electrode, an electrophoretic medium, and a plurality of rear pixel electrodes. To produce a high-resolution display, e.g., for displaying images, each pixel electrode 130 is individually-addressable without interference from adjacent pixels so that an image file is faithfully reproduced on the display. One way to achieve this objective is to provide an array of non-linear elements, such as transistors or diodes, with at least one non-linear element associated with each pixel, to produce an “active matrix” display. (See FIG. 2.) An addressing or pixel electrode 130, which addresses one pixel, is connected to an appropriate voltage source through the associated non-linear element. Typically, when the non-linear element is a transistor, the pixel electrode is connected to the drain of the transistor, and this arrangement will be assumed in the following description, although it is essentially arbitrary and the pixel electrode could be connected to the source of the transistor.

It should be noted that the magnitude of the voltage that can be provided in such row-column driving can be limited by the materials from which the non-linear element, e.g., thin film transistor, is fabricated. In many embodiments the semiconductor material is silicon, especially amorphous silicon, which is able to control driving voltages on the order of #15 V. In other embodiments, the semi-conductor of the thin-film-transistor may be a metal oxide, such indium gallium zinc oxide (IGZO), which allows for a wider range of driving voltages, e.g., up to ±30 V e.g., as described in U.S. Patent Publication No. 2022-0084473. This design feature is particularly pertinent when driving waveforms to sort the pigments of a multi-particle system. In such systems, it is beneficial to provide at least five voltage levels (high positive, low positive, zero, low negative, high negative), and with higher total voltages, it is easier to separate the particles. For greater details, see U.S. Patent Publication 2021-0132459. In some embodiments, voltages having a larger magnitude than ±30 V (e.g., ±35 V, ±45 V) can be applied during row-column driving by applying voltages other than substantially ground (e.g., 0 V) to the common voltage reference supply when driving the display.

Thin-film-transistor (TFT) backplanes usually have only one transistor per pixel electrode or propulsion electrode. Conventionally, each pixel electrode has associated therewith a capacitor electrode such that the pixel electrode and the capacitor electrode form a capacitor; see, for example, International Patent Application WO 01/07961. In some embodiments, N-type semiconductor (e.g., amorphous silicon) may be used to from the transistors and the “select” and “non-select” voltages applied to the gate electrodes can be positive and negative, respectively.

Additional details of the row-column addressing used in an “active matrix” display are shown in FIG. 2. An addressing or pixel electrode, which addresses one pixel, is fabricated on a substrate 202 and connected to the appropriate voltages via lines 204 and 206 through the associated non-linear element. It is understood that the voltages supplied on lines 204 and 206 may originate from separate circuit elements or the voltages can be delivered with the assistance of a single power supply and a power management integrated circuit (“PMIC”). In some instances, an intervening source controller 220 and a gate controller 230 are used to control the supplied voltages to the source and gate lines, however in other embodiments the controller 260 is configured to control the entire addressing process, including coordinating the gate and source lines.

One of skill in the art will appreciate that the controller 260 of the present invention can be implemented in a number of different physical forms and can utilize a variety of analog and digital components. For example, the controller 260 can include a general purpose microprocessor in conjunction with appropriate peripheral components (for example, one or more digital-to-analog converters, “DACs”) to convert the digital outputs from the microprocessor to appropriate voltages for application to pixels. Alternatively, the display controller circuitry can be implemented in an application specific integrated circuit (“ASIC”) or field programmable gate array (“FPGA”). One of skill in the art will appreciate that the display controller circuitry can include both processing components and power management circuitry such as the PMIC described above.

It is also to be understood that FIG. 2 is an illustration of an exemplary layout of an active matrix backplane 200 but that, in reality, the active matrix has depth and some elements, e.g., the TFT, may actually be underneath the pixel electrode, with a via providing an electrical connection from the drain to the pixel electrode above. Further, the electrical traces that route signals from the gate and/or source controllers to the respective row and column select signals of the active matrix backplane 200 can be T-wires that run perpendicular to the signals they connect with.

Conventionally, in high resolution arrays, the pixels are arranged in a two-dimensional array of rows and columns, such that any specific pixel is uniquely defined by the intersection of one specified row and one specified column. The sources of all the transistors in each column are connected to a single column (scan) line 206, while the gates of all the transistors in each row are connected to a single row (gate) line 208; again the assignment of sources to rows and gates to columns is conventional but essentially arbitrary, and could be reversed if desired. The gate lines 208 are optionally connected to a gate line driver 212, which essentially ensures that at any given moment only one row is selected, i.e., that there is applied to the selected row electrode a select voltage such as to ensure that all the transistors in the selected row are conductive, while there is applied to all other rows a non-select voltage such as to ensure that all the transistors in these non-selected rows remain non-conductive. The column scan lines 206 are optionally connected to scan line drivers 210, which place upon the various scan lines 206 voltages selected to drive the pixels in the selected row to their desired optical states. (The aforementioned voltages are relative to a common top electrode (e.g., VCOM) which is not shown in FIG. 2.)

With conventional driving, after a pre-selected interval known as the “line address time” the selected row is deselected, the next row is selected, and the voltages on the column drivers are changed so that the next line of the display is written. This process is repeated in a linear fashion so that the entire display is written in a row-by-row manner. As shown in FIG. 2, the temporal spacing between gate voltage pulses of respective frames is typically constant, and represent the rhythm of line by line addressing. Notably, the invention does not implement an even spacing between respective gate voltage pulses for a given address row of pixel electrodes.

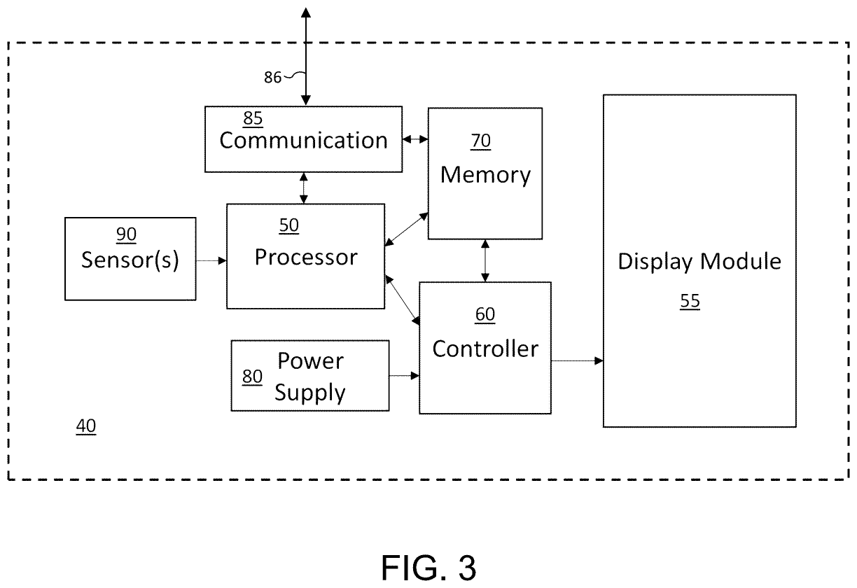

The active matrix backplane described with respect to FIG. 2 can be coupled to an electro-optic medium, e.g., as illustrated in FIGS. 1A and 1B, and typically sealed to create a display module 55, as shown in FIG. 3. Such a display module 55 becomes the focus of an electrophoretic display 40. The electrophoretic display 40 will typically include a processor 50 that is configured to coordinate the many functions relating to displaying content on the display module 55, and to transform “standard” images, such as sRGB images to a color regime that best duplicates the image on the display module 55. Of course, if the electrophoretic display is being used as a sensor or counter, the content may relate to other inputs.

The processor 50 is typically a mobile processor chip, such as made by Freescale or Qualcomm, although other manufacturers are known. The processor 50 is in frequent communication with the non-transitory memory 70, from which it pulls image files and/or look up tables to perform, for example, color and grayscale image transformations or to retrieve driving waveform information, as noted below. The non-transitory memory 70 may also include gate driving instructions to the extent that a particular optical transition may require a different gate driving pattern. The electrophoretic display 40 may have more than one non-transitory memory chip. The non-transitory memory 70 may be flash memory. In many embodiments, the non-transitory memory 70 is incorporated directly into the end consumer device by incorporating all of the elements of FIG. 3 into a circuit board or package. However, in some instances, the driving circuitry is not directly incorporated into the display, such as when the display becomes the exterior of an object such as an automobile.

Waveforms are typically stored in the non-transitory memory 70, however they can also be incorporated into the controller 60 or the processor 50 or they can be stored on the cloud and downloaded via communications 85. A number of look-up tables can be used to facilitate the methods of the invention, especially to provide time shifted waveforms to the controller 60 as appropriate. In particular for a given transition from a first color to a second color in an electrophoretic medium having eight primaries a look up table could include instructions for updating from color 1 to a later color (with no time offset) in look-up slots 1 to 8, while instructions for updating from color 1 to a later color (with a first time offset) in look-up slots 9 to 16, and instructions for updating from color 1 to a later color (with a second time offset) in look-up slots 17 to 24, and so on. Of course, this type of look-up table can also be indexed for improved performance in view of operating conditions, such as device temperature, battery health, front-light color, front-light intensity, etc.

Once the desired image has been converted for display on the display module 55, the specific image instructions are sent to a controller 60, which facilitates voltage sequences being sent to the respective thin film transistors (described above). Such voltages typically originate from one or more power supplies 80, which may include, e.g., a power management integrated chip or PMIC.

The electrophoretic display 40 may additionally include communication 85 for receiving images and instructions and for communications with devices external to the electrophoretic display 40, as denoted by arrow 86. In some embodiments, communication 85 includes components and software to enable wireless communications using Wi-Fi or Bluetooth protocols. In some embodiments, communication 85 includes components and software to enable data to be transmitted and received via an external-facing connector configured according to an industry standard such as Universal Serial Bus (“USB”) or Ethernet. Images and instructions received by communication 85 can be transmitted to the processor 50 before being saved in memory 70. As shown in FIG. 3, in some embodiments, communication 85 has an interface with memory 70 enabling images and instructions received by communication 85 to be saved in memory 70.

The electrophoretic display 40 may additionally include one or more sensors 90, which may include a temperature sensor and/or a photo sensor, and such information can be fed to the processor 50 to allow the processor 50 to select an optimum look-up-table when such look-up-tables are indexed for ambient temperature or incident illumination intensity or spectrum. In some instances, multiple components of the electrophoretic display 40 can be embedded in a singular integrated circuit. For example, a specialized integrated circuit may fulfill the functions of processor 50 and controller 60.

The layout of the active matrix backplane 200 shown in FIG. 2 and the various components of electrophoretic display 40 shown in FIG. 3 are provided as examples to facilitate the readers understanding of possible configurations of these structures. FIGS. 2 and 3 do not necessarily include all of the elements and components that may be present in an actual electrophoretic display incorporating an active matrix backplane, or all of the electrical traces and connections between the different elements of the backplane.

In practice, conventional video rate displays using non-bistable media, such as the phosphors on cathode ray tubes and conventional liquid crystal displays, require frame rates in excess of about 25 frames per second (fps) to provide acceptable video quality. (Video display at 15 fps is common on internet videos but results in a noticeable lack of video quality.) However, it has been found that bistable, and certain other, electro-optic displays can produce good quality images at frame rates substantially below 25 fps, and in the range of about 10 to about 20 fps, preferably about 13 to about 20 fps. Experienced observers have determined that encapsulated electrophoretic displays running at 15 fps can produce video quality which appears substantially equal to that produced by non-bistable displays running at about 30 fps.

In addition, improvements have been made to the display controller architecture to allow a cleaner implementation of video on a controller for a bistable electro-optic display. For example, U.S. Pat. No. 9,721,495, which is incorporated herein by reference in its entirety, describes an improved display controller having a memory structure that provides a rotating set of image buffer regions. This structure allows the host processor to write images to the frame buffer at any arbitrary video frame rate (as fast as the host controller can decode the video frames), and the display controller may retrieve and update the display with the latest whole video frame image written by the host processor. The image buffer never gets full since the host processor can always simply overwrite image buffer slots that are not currently in use by the display controller. In this way the display controller can also keep time with the video frame rate (introducing some video frame rate jitter in the process).

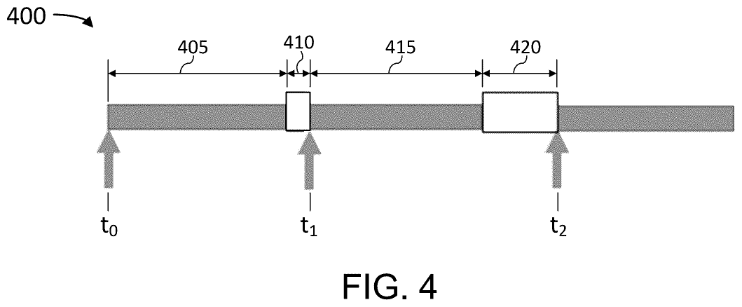

Ideally, each successive image in a sequence for animation or video content needs to be received into the display controller's update buffer and be ready for updating within the time it takes to update the display with the previous image in the sequence. FIG. 4 shows an idealized timeline 400 for updating a display with a sequence of images. At time to, the display controller begins updating a first image in the sequence to the display module screen. During the update time for the first image, which includes waveform update time 405 and dwell time 410, a second image in the sequence must be received into the display controller's update buffer and be ready to begin being updated to the display module screen at time t₁. Similarly, at time t₁, the display controller begins updating the second image in the sequence to the display module screen. During the update time for the second image, which includes waveform update time 415 and dwell time 420, a third image in the sequence must be received into the display controller's update buffer and be ready to begin being updated to the display module screen at time t₂, and so on for each image in the sequence.

Regarding update time, when update time is not critical, such as for eReader applications where there can be several minutes between each page turn requiring an image update, a display may operate using a drive scheme such as “Global Complete” (“GC mode”) where each pixel has the ability to fully transition from a first optical state to a second optical state during each image update. Of course, as described in e.g., U.S. Pat. No. 10,657,869, such updates can be time consuming (e.g., 1 second or more), especially when DC balancing and remnant voltage management are required to achieve the highest quality colors. For this reason, displays typically use faster update schemes for displaying animated or video content, where a very quick update is desired and the user is willing to sacrifice fidelity in exchange for a faster update experience. Such quicker update schemes are typically known as “Direct Update” (“DU mode”) and typically involve simply driving the electrophoretic medium to the black and white extents. See, e.g., U.S. Pat. No. 9,672,766. For higher end products, such as color eReaders/tablets, there may be multiple kinds of each mode, depending upon the content that is being displayed. Additional modes, such as animation (a.k.a. “A2 mode”) may also be included, and the display controller may be programmed to automatically switch between modes depending upon the content being displayed. Update times for the faster update schemes are typically on the order of 100 ms.

Given the reduced update times that can be achieved using the faster update schemes, as screen sizes and resolutions increase, along with the pixel density of display backplanes, it can be difficult for each successive image in a sequence to be received and stored in the display controller's update buffer before the display controller has finished updating the display module screen with the prior image in the sequence. In particular, the size of images can become a burden for the display system when presenting sequences of images that need to be updated to the display in quick succession (e.g. videos, animations). For example, images are typically 8-bit formatted (also referred to as “Y8” images) meaning that the image includes 8 bits of data for each pixel in the image. Accordingly, a Y8 image having a 1920×1440 resolution has a size of approximately 2.76 megabytes or MB.

Many conventional electrophoretic displays receive images via a USB interface operating at approximately 27 MB/s. Accordingly, transfer of a Y8 image having a resolution of 1920×1440 takes approximately 100 ms. This is comparable to the display controller's image update time when using waveforms from a faster drive scheme which typically require 8-9 frames to complete. At a frame rate of 85 Hz, the display controller's image update time is therefore approximately 95 ms to 105 ms for each image. However, as the update time of the waveforms is reduced and the resolution of the display increases, the burden of the image transfer alone can create backlogs that makes smooth animation a challenge in existing display systems.

It is important to note that for animation and video content, the waveforms used from the faster drive schemes that are short enough in duration to allow for smooth animation (e.g., DU, A2) can typically only drive pixels to just black or white states. With multi-level driving it is possible to provide an additional 2 intermediate gray states for better spatial smoothness. Hence, images including only 1 bit or at most 2 bits per pixel are all that is needed for updating a display with animation or video content. Accordingly, the inventive subject matter described herein utilizes the specific nature of animation and video content to reduce the image transfer burden on the display system by transferring the consecutive images of sequenced content as 1-bit formatted (or “Y1”) images or 2-bit formatted (or “Y2”) images from the host system to the display controller's update buffer.

Considering a Y1 image having a 1920×1440 resolution, the image size is now 345.6 kilobytes or KB. Assuming the image is received via a USB interface operating at approximately 27 MB/s, transfer of a Y1 image having a resolution of 1920×1440 takes approximately 12.8 ms. Further, considering a Y2 image having a 1920×1440 resolution, the image size is now 691.2 KB. Assuming the image is received via a USB interface operating at approximately 27 MB/s, transfer of a Y2 image having a resolution of 1920×1440 takes approximately 25.6 ms. (It is noted that the rate at which the image data can be written to and accessed from the update memory is significantly faster than the image transfer rate, and is therefore considered negligible for the purposes of this description.) Accordingly, transferring images in Y1 or Y2 format can significantly reduce the time required to get images from the host system to the display controller's update memory.

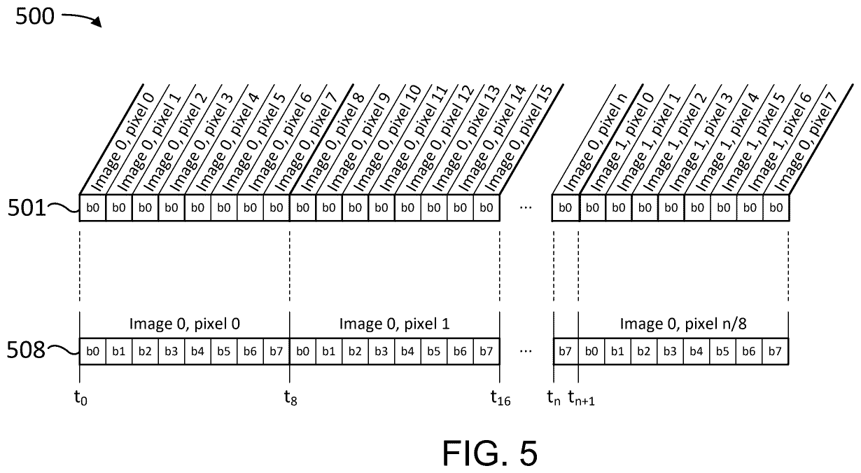

FIG. 5 is a diagram 500 illustrating pixel data organized into two sequences using different pixel data formats. Each image includes pixel data for “n” distinct pixels. The pixel data comprises color information about the plurality of display pixels. In sequence 508, the images are transferred in Y8 format where there are 8 bits of data for each pixel in the image. At time to, the transfer of image 0 begins with the transfer of bit b₀ of pixel 0. At time to, all 8 bits of pixel 0 have been transferred, and the transfer of image 0, pixel 1 begins with the transfer of bit b₀ of pixel 1. By time t₁₆, all 8 bits of pixel 1 have been transferred, and the transfer of image 0, pixel 2 begins with the transfer of bit b₀ of pixel 2.

In sequence 501, the images are transferred in Y1 format where there is 1 bit of data for each pixel in the image. At time to, the transfer of image 0 begins with the transfer of bit b₀ of pixel 0. Because the data is in Y1 format, by time t₈, all of the data in image 0 for pixels 0-7 has been transferred, and the transfer of image 0, pixel 8 begins with the transfer of bit b₀ of pixel 8. Further, by time t₁₆, all of the data in image 0 for pixels 8-15 has been transferred, and the transfer of image 0, pixel 16 begins with the transfer of bit b₀ of pixel 16. Accordingly, in this example, the sequence of images has been remapped into a series of bytes that is arranged such that in each byte, each bit corresponds to a different pixel location from a same image.

At time tₙ, transfer of the data for the n^{th} (e.g., last) pixel of image 0 begins, and at time tₙ₊₁, the transfer of image 1 begins with the transfer of bit b₀ of pixel 0. Referring to sequence 508, image 0 is still being transferred at time tₙ₊₁, with bit b₀ of pixel n/8 beginning at that time. Further, the electrophoretic display can be sequentially updated by applying a fast update waveform selected from a Direct Update (DU) driving mode or an Animation (A2) driving mode since the pixels are only driven to black or white states.

Accordingly, the timewise comparison of the transfer of sequence 508 and sequence 501 in FIG. 5 illustrates the significant gain in transfer rate that is achieved using Y1 formatted images instead of conventional Y8 formatted images. In particular, the transfer of Y1 images takes ⅛^{th} the time of Y8 images.

It is noted that FIG. 5 shows a serial transfer of the bits of pixel data in order to conceptually illustrate the increased density of image information that can be received in the same amount of time when using the described method. However, the pixel data shown being transferred is not an actual representation of the data transfer in the sense that it does not include bits associated with any overhead of the communications protocol used between the host interface and the display controller. Further, the method is not limited to serial transfers of the pixel data or to a particular data transfer protocol such as USB. For example, the pixel data can be sent over a parallel interface where several bits of data are received simultaneously. Similarly, the bit order of the pixel data can be different than what is shown in FIG. 5.

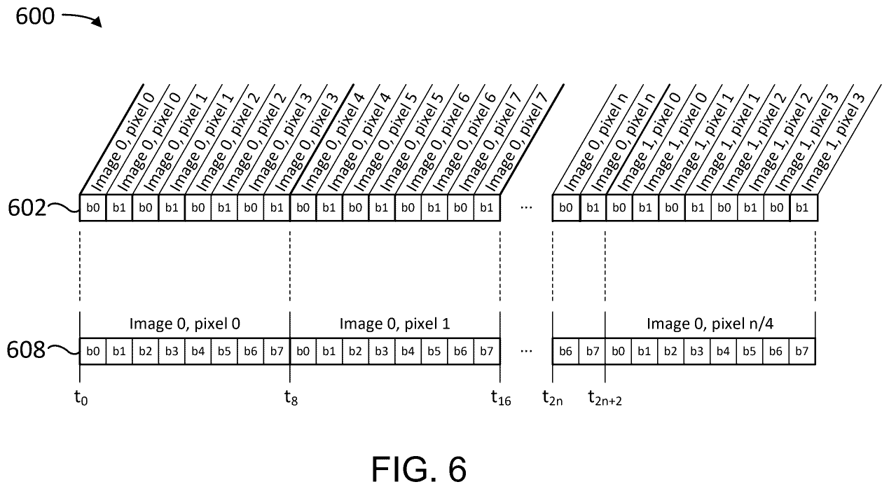

FIG. 6 is a diagram 600 illustrating pixel data organized into two sequences using different pixel data formats. Each image includes pixel data for “n” distinct pixels. The pixel data comprises color information about the plurality of display pixels. Sequence 608 is the same as sequence 508 from FIG. 5. In sequence 602, the images are transferred in Y2 format where there are 2 bits of data for each pixel in the image. At time to, the transfer of image 0 begins with the transfer of bit b₀ of pixel 0. Because the data is in Y2 format, by time to, all of the data in image 0 for pixels 0-3 has been transferred, and the transfer of image 0, pixel 4 begins with the transfer of bit b₀ of pixel 4. Further, by time t₁₆, all of the data in image 0 for pixels 4-7 has been transferred, and the transfer of image 0, pixel 8 begins with the transfer of bit b₀ of pixel 8.

At time t₂ₙ, transfer of bit b₀ for the n^{th} (e.g., last) pixel of image 0 begins, and at time t₂ₙ₊₂, the transfer of bit bi for the n^{th} pixel of image 0 ends and the transfer of image 1 begins with the transfer of bit b₀ of pixel 0. Referring to sequence 608, image 0 is still being transferred at time t₂ₙ₊₂, with bit b₀ of pixel n/4 beginning at that time. Further, the electrophoretic display can be sequentially updated by applying a fast update waveform selected from a fast driving mode since the pixels are only driven to one of four optical states.

Accordingly, the timewise comparison of the transfer of sequence 608 and sequence 602 in FIG. 6 illustrates the significant gain in transfer rate that is achieved using Y2 formatted images instead of conventional Y8 formatted images. In particular, the transfer of Y2 images takes ¼^{th} the time of Y8 images.

It is noted that FIG. 6 shows a serial transfer of the bits of pixel data in order to conceptually illustrate the increased density of image information that can be received in the same amount of time when using the described method. However, the pixel data shown being transferred is not an actual representation of the data transfer in the sense that it does not include bits associated with any overhead of the communications protocol used between the host interface and the display controller. Further, the method is not limited to serial transfers of the pixel data or to a particular data transfer protocol such as USB. For example, the pixel data can be sent over a parallel interface where several bits of data are received simultaneously. Similarly, the bit order of the pixel data can be different than what is shown in FIG. 6.

In practice, gaining the transfer speed advantages for animation and video content can be achieved by taking advantage of the fact that even full color electrophoretic displays enter a 2- or 4-state optical state mode for images that need to be updated to the display in quick succession. Accordingly, encoding the optical state of each pixel with 8 bits is unnecessary for such content, and minor modifications to the host system and display controller can achieve the gains discussed herein. For example, in a fast waveform driving scheme where the optical state of each pixel is either a black or white optical state, the host system can remap the 8 bits of pixel data to a single bit that is transferred to the display controller. The display controller can in turn be configured to remap a pixel value of 0 in Y1 format at (i,j) pixel to 00000000 in Y8 format at (i,j) pixel. Similarly, the display controller can in turn be configured to remap a pixel value of 1 in Y1 format at (i,j) pixel to 11111111 in Y8 format at (i,j) pixel.

Similarly, a Y2 image can be expanded to an 8-bit Y8 format image in the display controller's update buffer for normal execution of Y8 formatted images. Such expansion can take the form of: remapping a received value of 00 in Y2 image format at (i,j) pixel expanded to 00000000 in Y8 image format at (i,j) pixel; remapping a received value of 01 in Y2 image format at (i,j) pixel to 01010101 in Y8 image format at (i,j) pixel; remapping a received value of 10 in Y2 image format at (i,j) pixel to 10101010 in Y8 image format at (i,j) pixel; and remapping a received value of 11 in Y2 image format at (i,j) pixel to 11111111 in Y8 image format at (i,j) pixel.

Accordingly, using the methods described herein, the effective transfer rate for sequenced images such as animation and video content can be significantly reduced.

Further building on the concepts described above, a method is provided for efficiently transferring a sequence of images to an electrophoretic display by packetizing Y1- or Y2-remapped images prior to transfer. For example, rather than transmitting each image individually in an eight-bit-per-pixel data format (e.g., Y8), the host system can remap x consecutive images in the sequence into a reduced-bit pixel data format (e.g., Y1, Y2) as described above, and packetize the remapped image data into a series of bytes.

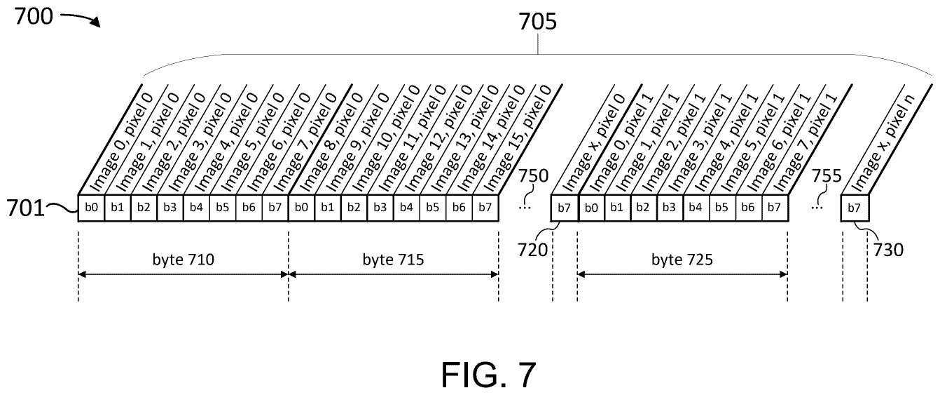

FIG. 7 is a diagram 700 illustrating an exemplary byte format for packet 705 of remapped image data for x consecutive images, where each image includes n pixels. Accordingly, a data packet includes pixel data in a first pixel data format. The pixel data correspond to a first plurality of consecutive images from the sequence of images (e.g., video content, animation).

In diagram 700, a sequence of Y8-formatted images has been converted to a Y1 pixel data format. Accordingly, each bit in sequence 701, represents data for one pixel. In this exemplary packetization scheme, each bit within a byte corresponds to a pixel from a different image. For example, the least significant bit of byte 710 represents pixel data for pixel 0 in image 0, while the most significant bit of byte 710 represents pixel data for pixel 0 of image 7. Byte 715 is similarly used to represent pixel data for pixel 0 in images 8 through 15, respectively. Packetization continues in this fashion for pixel 0 of each subsequent image in packet 705, as denoted by ellipsis 750. Accordingly, in this example, the series of bytes is arranged such that in each byte, each bit corresponds to the same pixel location (e.g., pixel 0) from eight different images (e.g., images 0-7).

Once pixel data for pixel 0 of image x (e.g., the last image in packet 705, denoted by 720 in FIG. 7) has been packetized, the method proceeds to packetize pixel data for pixel 1 from each image in packet 705. For example, the least significant bit of byte 725 represents pixel data for pixel 1 in image 0, while the most significant bit of byte 725 represents pixel data for pixel 1 of image 7.

Packetization continues in this fashion for the remapped pixel data of the n pixels in each of the x images in packet 705, as denoted by ellipsis 755, until pixel data for pixel n of image x (e.g., the last pixel of the last image in packet 705, denoted by 730 in FIG. 7) has been packetized.

It is noted that the bits of packet 705 in FIG. 7 are shown as a serial sequence of bits to conceptually illustrate the contents of a packet of remapped pixel data. A packet such as packet 705 can be organized and stored in any suitable data structure.

The packetized pixel data in packet 705 including the remapped x consecutive images is then transmitted from the host system to the update buffer of the electrophoretic display's display controller. Upon receipt of packet 705, the display controller unpacks each byte of Y1 pixel data and remaps each bit into an eight-bit pixel data format (e.g., Y8) suitable to convey a grayscale value for the pixel to the display controller. For example, a bit value of 0 is remapped to 00000000, and a bit value of 1 is remapped to 11111111, as described above. Accordingly, the display controller processes each byte of the packetized remapped images to extract pixel data for each image in the sequence. All of the bits corresponding to the pixels of image 0 are remapped in this manner until values for all of the n pixels of image 0 are known. Accordingly, the display controller assembles this first image of the first plurality of consecutive images from the pixel data in the second pixel data format. The display is then updated with the first image. In some embodiments, the update buffer of the display controller is sufficiently large, and multiple images are expanded and stored concurrently, with each image being placed at a distinct memory offset.

The process can be repeated for subsequent packets of remapped images, thereby supporting efficient and continuous animation or video playback on the electrophoretic display. For example, the method enables the transfer of a packet of remapped n images to the electrophoretic display's update buffer such that the images can be processed and ready for sequential updating to the display within a time interval not exceeding [n·(image update time)]. Further, the electrophoretic display can be sequentially updated with the images by applying a fast update waveform selected from a Direct Update (DU) driving mode or an Animation (A2) driving mode. The method therefore advantageously overcomes the transfer bottlenecks and unpredictable delays in communications between the host system and the electrophoretic display that cause conventional methods to be unable to maintain continuous animation. The inventive method takes advantage of the fact that the time needed to transfer each packet of remapped pixel data for several images is much shorter than the time needed to process a packet and update the display with each image.

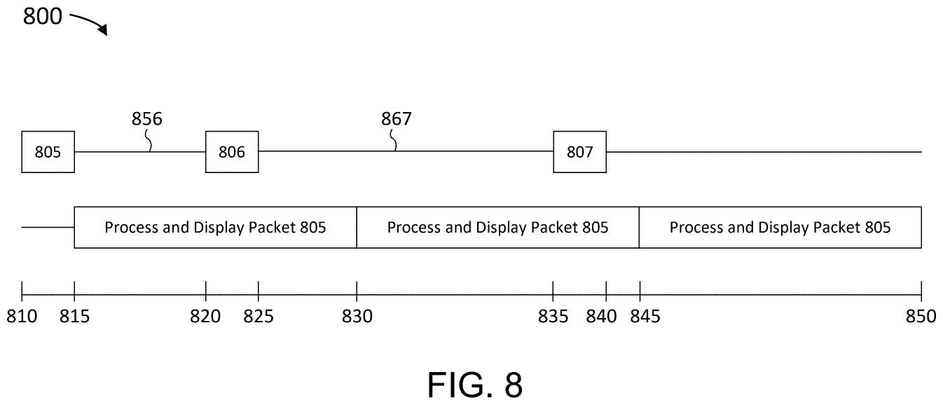

FIG. 8 is a timing diagram 800 showing the transfer of packets of remapped pixel data to be processed and displayed on an electrophoretic display. At time 810, the host system transfers packet 805 (e.g., a first data packet) to the update buffer of the electrophoretic display's display controller. At time 815, packet 805 has completed its transfer, and the display controller begins processing the remapped pixel data in packet 805. For example, the display controller can unpack each byte of Y1 pixel data and remap each bit into an eight-bit pixel data format (e.g., Y8) suitable to convey a grayscale value for the pixel to the display controller. Once all of the pixel data for a first image in the packet is remapped, the first image is displayed on the electrophoretic display. The process is repeated for each subsequent image in packet 805.

At time 820, the host system transfers packet 806 (e.g., a second data packet) to the update buffer of the electrophoretic display's display controller. At time 825, packet 806 has completed its transfer. However, the display controller is still processing and displaying images from packet 805.

In some embodiments, the display controller finishes processing the images in packet 805 before all of the images have been displayed. In this case, the display controller can begin processing the remapped pixel data in packet 806, but will wait to begin displaying the images from packet 806 until display of the images from packet 805 completes at time 830.

In some embodiments, the remapped pixel data in packet 805 remains stored in memory until the display controller has completed processing and displaying the images from packet 805 at time 830. The display controller then begins processing the remapped pixel data in packet 806, and sequentially displaying the images in packet 806 as described above.

At time 835, the host system transfers packet 807 (e.g., a third data packet) to the update buffer of the electrophoretic display's display controller. At time 840, packet 807 has completed its transfer. However, the display controller is still processing and displaying images from packet 806.

In some embodiments, the display controller finishes processing the images in packet 806 before all of the images have been displayed. In this case, the display controller can begin processing the remapped pixel data in packet 807, but will wait to begin displaying the images from packet 807 until display of the images from packet 806 completes at time 845.

In some embodiments, the remapped pixel data in packet 806 remains stored in memory until the display controller has completed processing and displaying the images from packet 806 at time 845. The display controller then begins processing the remapped pixel data in packet 807, and sequentially displaying the images in packet 807 as described above until time 850.

Notably shown in FIG. 8, the difference in latency or arrival time between packet 806 and 807 (denoted as latency 867 in FIG. 8) is much longer than the latency between packet 805 and 806 (denoted as latency 856 in FIG. 8). Nonetheless, by remapping the pixel data and sending multiple images in each packet, the method enables an electrophoretic display to provide continuous video or animation playback. Further, because the display controller handles remapping the data from a Y1 (or Y2) format to a Y8 format, the host system and data link do not require major changes. Accordingly, the inventive method described herein overcomes issues caused by transfer bottlenecks, and enables smooth playback of sequential content without overwhelming the data link or requiring expensive hardware upgrades.

It will be apparent to those skilled in the art that numerous changes and modifications can be made to the specific embodiments of the invention described above without departing from the scope of the invention. Accordingly, the whole of the foregoing description is to be interpreted in an illustrative and not in a limitative sense.

1. A method for driving an electro-optic display having a plurality of display pixels, the method comprising:
receiving a first data packet comprising pixel data in a first pixel data format, the pixel data corresponding to a first plurality of consecutive images from a sequence of images;
remapping the pixel data in the first pixel data format to a second pixel data format;
assembling a first image of the first plurality of consecutive images from the pixel data in the second pixel data format; and
updating the electro-optic display with the first image.

2. The method of claim 1 wherein the pixel data comprises color information about the plurality of display pixels.

3. The method of claim 2 wherein the first pixel data format encodes the color information about the plurality of display pixels into one bit per display pixel.

4. The method of claim 2 wherein the first pixel data format encodes the color information about the plurality of display pixels into two bits per display pixel.

5. The method of claim 2 wherein the second pixel data format encodes the color information about the plurality of display pixels into eight bits per display pixel.

6. The method of claim 1 wherein the first data packet is arranged such that in each byte of the first data packet, each bit corresponds to a same pixel location from eight different images.

7. The method of claim 1 wherein the first data packet is arranged such that in each byte of the first data packet, each bit corresponds to a different pixel location from a same image.

8. The method of claim 1 further comprising:
assembling each additional image of the first plurality of consecutive images from the pixel data in the second pixel data format; and
sequentially updating the electro-optic display with the additional images of the first plurality of consecutive images.

9. The method of claim 1 further comprising:
receiving a second data packet comprising pixel data in the first pixel data format, the pixel data corresponding to a second plurality of consecutive images from the sequence of images; and
remapping the pixel data in the first pixel data format to the second pixel data format before all images from the first data packet have been updated to the electro-optic display.

10. The method of claim 1 wherein updating the electro-optic display comprises applying a fast update waveform selected from a Direct Update (DU) driving mode or an Animation (A2) driving mode.

11. A method for transferring and displaying a sequence of images on an electrophoretic display comprising a plurality of display pixels, the method comprising:
remapping, by a host system, a plurality of consecutive images from the sequence of images an eight-bit-per-pixel format (Y8) to a reduced-bit format selected from a one-bit-per-pixel format (Y1) or a two-bit-per-pixel format (Y2);
packetizing, by the host system, the remapped images into a series of bytes such that each bit within a byte corresponds to pixel data for the images in the sequence of images;
transmitting, by the host system, the packetized remapped images to an update buffer of a display controller of the electrophoretic display;
processing, by the display controller, each byte of the packetized remapped images to extract pixel data for each image in the sequence;
expanding, by the display controller, each bit of the extracted pixel data from the one-bit-per-pixel format (Y1) or the two-bit-per-pixel format (Y2) to an eight-bit-per-pixel format (Y8) to reassemble each image of the sequence of images; and
sequentially updating, by the display controller, the electrophoretic display with each reassembled image of the sequence of images.

12. The method of claim 11 wherein the pixel data comprises color information about the plurality of display pixels.

13. The method of claim 11 wherein the series of bytes is arranged such that in each byte, each bit corresponds to a same pixel location from eight different images.

14. The method of claim 11 wherein the series of bytes is arranged such that in each byte, each bit corresponds to a different pixel location from a same image.

15. The method of claim 11 wherein sequentially updating the electrophoretic display comprises applying a fast update waveform selected from a Direct Update (DU) driving mode or an Animation (A2) driving mode.
